(19) United States
(12) Patent Application Publication
(10) Pub. No.: US 2016/0117618 A1
(43) Pub. Date: Apr. 28, 2016

(54) DETERMINING ALTERNATIVE TRAVEL ITINERARIES USING CURRENT LOCATION

(71) Applicant: Google Inc., Mountain View, CA (US)

(72) Inventors: Yi Wang, Acton, MA (US); Nick Ning, Bedford, MA (US); Stephen Leslie Peters, Cambridge, MA (US)

(21) Appl. No.: 14/521,060

(22) Filed: Oct. 22, 2014

(51) Int. Cl. G06Q 10/02

(52) U.S. Cl. CPC G06Q 10/025

(57) ABSTRACT

Methods, systems, and apparatus, including computer programs encoded on a computer storage medium, for detecting travel information. In one aspect, a method includes obtaining current flight status information for plural flights and using the information to determine that a user's flight itinerary is delayed or canceled, determining alternative flight itineraries to the flight itinerary, and providing alternative flight itineraries for display on a user device. Determining alternative flight itineraries includes obtaining a current geographical location of the user, obtaining a collection of candidate alternative flight itineraries occurring within a specified time frame using the current geographical location of the user regardless of the origin or connection locations identified in the user's flight itinerary, ranking the candidate alternative flight itineraries, determining current flight status information for a specified number of highest-ranked candidate alternative flight itineraries, and filtering the highest-ranked candidate alternative flights based on the current flight status.

### BACKGROUND

This specification relates to information retrieval.

Conventional online travel booking sites allow users to identify and purchase travel according to a specified itinerary. For example, a user can purchase one or more tickets for airline flights associated with a flight itinerary, with each flight departing from a first location at a particular date and time and arriving at another location at a particular date and time. Following the purchase of a particular flight itinerary, the user will typically follow the flight itinerary and complete the trip.

Existing flight itineraries can be affected by different factors, many of which may be out of control of the user. For example, flight delays and/or cancelations can be caused by weather conditions, equipment problems, and/or other factors. Flight delays can occur in (or be predicted at) various parts of an itinerary, such as before travel occurs or at some time after travel has commenced.

### SUMMARY

This specification describes technologies relating to determining alternative travel itineraries.

Travel itineraries can include specific modes of transportation and associated times. For example, a travel itinerary associated with airline travel can include flight information, carrier information, and dates/times of departures and arrivals.

A system can be used to determine re-accommodations, such as if a current travel itinerary in use by a traveling user is affected by one or more factors or events. For example, a user may complete part of a travel itinerary from City A to City C, such as a first leg flying from City A to City B. A flight from one point to another point is typically referred to as a leg. A flight from an origin location to a destination location can have one or more distinct legs. Thus, there may be a layover in City B for a connecting flight to City C as a second leg of the travel itinerary. In some cases, one or more problems may exist that are associated with the connecting flight, such as a problem with equipment, personnel, weather or some other problem that may cause the connecting flight to be canceled or delayed. At this time, the system can recommend a change in the user's flight itinerary that is based on the cancelation or delay. The recommendation can further be based, for example, on the current location of a user. For example, alternative flight itineraries can be provided that consider a portion of the user's current itinerary that has already been completed. An alternative flight itinerary, for example, can consider the user's current location, such as at a connecting airport. In some implementations, location information associated with a user's current location can include the name of a city and/or airport, as well as a longitude and latitude, and optionally an altitude and/or elevation.

As an example, before providing alternatives to a user's original itinerary, a list of origins and destinations for each leg in the original itinerary can be searched. Airport locations for each of the origins and destinations can be determined and compared to the user's current location. If, for example, the user's current location is within a threshold distance, e.g., 50 miles, to an airport, then the user can be presumed to be in that location for the purpose of generating alternative flight itineraries. For example, consider a user who has booked a flight from Boston to Chicago and a continuing flight from Chicago to San Francisco. If the user is still in Boston, the alternative flight itineraries that the user would want to see would include alternatives that go from Boston to San Francisco. When the user is in Chicago, the user would want to see alternative flight itineraries that start from Chicago, such as if a problem with the current itinerary is discovered upon arriving in Chicago.

In general, one innovative aspect of the subject matter described in this specification can be embodied in methods that include the actions of obtaining current flight status information for a plurality of flights; using the current flight status information to determine that a flight itinerary of a user is delayed or canceled; determining one or more alternative flight itineraries to the flight itinerary that is delayed or canceled, including obtaining a current geographical location of the user, obtaining a collection of candidate alternative flight itineraries occurring within a specified time frame using the current geographical location of the user regardless of the origin or connection locations identified in the user's flight itinerary, ranking the collection of candidate alternative flight itineraries according to one or more criteria, determining current flight status information for a specified number of highest-ranked candidate alternative flight itineraries, and filtering the highest-ranked candidate alternative flights based on the current flight status to generate a group of alternative flight itineraries; and providing one or more of the group of alternative flight itineraries for display on a user device. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can each optionally include one or more of the following features. The current geographic location of the user corresponds to a connection location of the user's flight itinerary, and the candidate alternative flight itineraries have the connection location as an origin location and the destination of the user's flight itinerary as a destination location. Obtaining the collection of candidate alternative flight itineraries includes determining one or more candidate alternative flight itineraries having an origin airport within a threshold distance to the current geographical location of the user. The threshold distance depends on a departure time of the candidate alternative flight itinerary. Providing one or more of the group of alternative flight itineraries for display includes providing an indicator for display with particular alternative flight itineraries indicating a change in airport. Providing one or more alternative flight itineraries for display includes ordering the one or more alternative flight itineraries according to the estimated actual times instead of scheduled times for each alternative flight itinerary.

In general, another innovative aspect of the subject matter described in this specification can be implemented in systems, including a system including one or more computers configured to perform operations comprising: obtaining current flight status information for a plurality of flights; using the current flight status information to determine that a flight itinerary of a user is delayed or canceled; determining one or more alternative flight itineraries to the flight itinerary that is delayed or canceled, comprising: obtaining a current geographical location of the user, obtaining a collection of candidate alternative flight itineraries occurring within a specified time frame using the current geographical location of the user regardless of the origin or connection locations identified in the user's flight itinerary, ranking the collection of candidate alternative flight itineraries according to one or more criteria, determining current flight status information for a specified number of highest-ranked candidate alternative flight itineraries, and filtering the highest-ranked candidate alternative flights based on the current flight status to generate a group of alternative flight itineraries; and providing one or more of the group of alternative flight itineraries for display on a user device.

These and other implementations can each optionally include one or more of the following features. The current geographic location of the user corresponds to a connection location of the user's flight itinerary, and the candidate alternative flight itineraries have the connection location as an origin location and the destination of the user's flight itinerary as a destination location. Obtaining the collection of candidate alternative flight itineraries includes determining one or more candidate alternative flight itineraries having an origin airport within a threshold distance to the current geographical location of the user. The threshold distance depends on a departure time of the candidate alternative flight itinerary. Providing one or more of the group of alternative flight itineraries for display includes providing an indicator for display with particular alternative flight itineraries indicating a change in airport. Providing one or more alternative flight itineraries for display includes ordering the one or more alternative flight itineraries according to the estimated actual times instead of scheduled times for each alternative flight itinerary.

In general, another innovative aspect of the subject matter described in this specification can be implemented in computer storage media, including a computer storage medium encoded with a computer program, the program comprising instructions that when executed by one or more computers cause the one or more computers to perform operations. The operations comprise: obtaining current flight status information for a plurality of flights; using the current flight status information to determine that a flight itinerary of a user is delayed or canceled; determining one or more alternative flight itineraries to the flight itinerary that is delayed or canceled, comprising: obtaining a current geographical location of the user, obtaining a collection of candidate alternative flight itineraries occurring within a specified time frame using the current geographical location of the user regardless of the origin or connection locations identified in the user's flight itinerary, ranking the collection of candidate alternative flight itineraries according to one or more criteria, determining current flight status information for a specified number of highest-ranked candidate alternative flight itineraries, and filtering the highest-ranked candidate alternative flights based on the current flight status to generate a group of alternative flight itineraries; and providing one or more of the group of alternative flight itineraries for display on a user device.

These and other implementations can each optionally include one or more of the following features. The current geographic location of the user corresponds to a connection location of the user's flight itinerary, and the candidate alternative flight itineraries have the connection location as an origin location and the destination of the user's flight itinerary as a destination location. Obtaining the collection of candidate alternative flight itineraries includes determining one or more candidate alternative flight itineraries having an origin airport within a threshold distance to the current geographical location of the user. The threshold distance depends on a departure time of the candidate alternative flight itinerary. Providing one or more of the group of alternative flight itineraries for display includes providing an indicator for display with particular alternative flight itineraries indicating a change in airport. Providing one or more alternative flight itineraries for display includes ordering the one or more alternative flight itineraries according to the estimated actual times instead of scheduled times for each alternative flight itinerary.

The foregoing and other embodiments can each optionally include one or more of the following features, alone or in combination. The current geographic location of the user corresponds to a connection location of the user's flight itinerary, and the candidate alternative flight itineraries have the connection location as an origin location and the destination of the user's flight itinerary as a destination location. Obtaining the collection of candidate alternative flight itineraries includes determining one or more candidate alternative flight itineraries having an origin airport within a threshold distance to the current geographical location of the user. The threshold distance depends on a departure time of the candidate alternative flight itinerary. Providing one or more of the group of alternative flight itineraries for display includes providing an indicator for display with particular alternative flight itineraries indicating a change in airport. Providing one or more alternative flight itineraries for display includes ordering the one or more alternative flight itineraries according to the estimated actual times instead of scheduled times for each alternative flight itinerary.

Particular embodiments of the subject matter described in this specification can be implemented so as to realize one or more of the following advantages. Alternative flight itineraries can be generated that are based on a user's current location, e.g., at a connecting airport or in the air during a leg of the itinerary, as opposed to conventional systems that may base alternative flight itineraries on the user's original itinerary. A user's current location may or may not be part of the original itinerary, for example.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for performing re-accommodation of travel itineraries.

FIG. 2A is a block diagram showing example stages in a system for performing re-accommodation of travel itineraries.

FIG. 2B is a block diagram showing example stages for determining one or more alternative flight itineraries to the flight itinerary that is delayed or canceled.

FIG. 3A illustrates an example current itinerary user interface.

FIG. 3B illustrates an example alternative itineraries summary user interface.

FIG. 3C illustrates an example alternative itineraries detailed view user interface.

FIG. 4A is a flow diagram of an example method for performing re-accommodation of travel itineraries.

FIG. 4B is a flow diagram of an example method for determining one or more alternative flight itineraries to the flight itinerary that is delayed or canceled.

Like reference numbers and designations in the various drawings indicate like elements.

### DETAILED DESCRIPTION

Systems, methods, and computer program products are described for performing re-accommodation of travel itineraries, such as flight itineraries associated with airline travel. For example, if one or more flights of a user's flight itinerary are canceled or delayed due to weather or some other reason, suggested re-routing options can be determined automatically and provided to the user. Different types of information and/or approaches can be used in determining the re-routing options. For example, re-routing can be based, at least in part, on location information, including the user's current location.

In some implementations, re-routing options can take into account the user's preferences of avoiding certain airports (e.g., based on past experiences), or avoiding travel after a certain time-of-day (e.g., to avoid red-eye flights). In some implementations, re-routing can consider a user's preference to accept local accommodations rather than making different travel arrangements. In some implementations, a user's travel preferences can be stored and/or made available by an airline, a travel agency, an online or third-party source, or in some other way.

While the examples in this description focus primarily on airline travel and associated itineraries, other types of travel and itineraries can also be handled by the methods and systems described herein. For example, re-accommodation of airline itineraries can be integrated with other forms of transportation, such as rental car, taxi, bus, subway, train, boat, ferry and/or other arrangements or aspects of travel.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

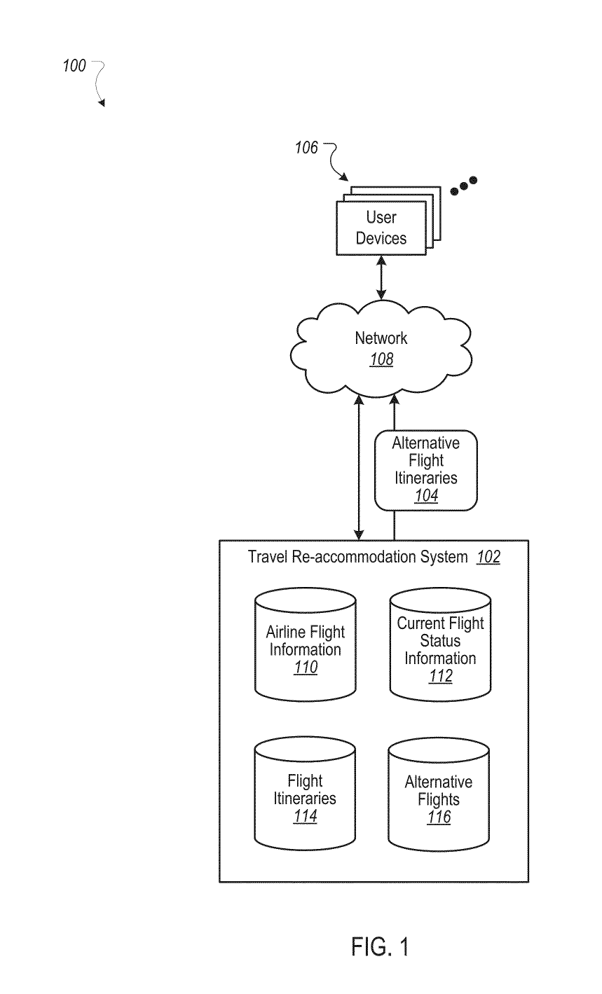

FIG. 1 is a block diagram of an example environment 100 for performing re-accommodation of travel itineraries. Re-accommodation, for example, can pertain to determining alternative itineraries, including different routes, and providing the alternative itineraries for presentation to a user. The environment 100 can include a travel re-accommodation system 102 that provides, for example, alternative flight itineraries 104 to user devices 106. For example, a user device 106 associated with a particular user can receive the alternative flight itineraries 104 for a flight itinerary for which the travel re-accommodation system 102 has determined alternative flight arrangements for the user, such as for a canceled or delayed flight. Communication between the user devices 106 and the travel re-accommodation system 102 can include the use of a network 108, such as a combination of the Internet, wide area networks (WANs), local area networks (LANs), other networks, or combinations thereof. User devices 106 can include, for example, mobile devices associated with the user, as well as kiosk computers at airports. Other configurations of the environment 100 are possible, including the use of external systems that provide information (e.g., weather information) to the travel re-accommodation system 102.

In some implementations, the travel re-accommodation system 102 can be a stand-alone application that runs, for example, on a user's user device 106. In some implementations, the travel re-accommodation system 102 can be provided on, or accessible from, a web page, such as provided by one or more airlines or provided by third-parties.

In some implementations, the environment 100 includes plural data stores that can be stored locally by the travel re-accommodation system 102, stored somewhere else and accessible using the network 108, generated as needed from various data sources, or some combination thereof. A data store of airline flight information 110, for example, includes information for flights associated with one or more air carriers, including general airline flight information and including information for specific flights for which there are user itineraries. For example, the information can include flight numbers/identifiers, scheduled departure/arrival dates/times, airport information, carrier information, equipment and personnel information, a set of dates on which the flight operates, and other information associated with each flight and/or its execution.

A data store of current flight status information 112, for example, includes real-time status information for each of the flights identified in the data store of airline flight information 110. For example, the real-time status information can identify which flights are currently (or forecast to be) on time, delayed, canceled or some other status. The status information can also include, for example, reasons contributing to a current status, such as reasons associated with equipment, personnel, weather, or some other reason. In some implementations, current flight status information can be received from airlines, received from third-party flight monitoring systems, monitored by the system, obtained in aggregated form from a third party, and/or received from other sources.

A data store of flight itineraries 114 can include information that identifies one or more flights that are included in each itinerary, such as on a per-user basis. The information can also include information identifying the user(s) with whom the flight itineraries are associated. Itinerary information can also monitor parts of each itinerary that are completed or in progress. For example, the information can indicate that User A has completed the leg of the itinerary that includes a flight from City B to City C. In some implementations, information stored in the data store of flight itineraries 114 can include user information, such as seating, airline, schedule, cost tolerance and/or other user preferences that can be used to determine alternative flights. In some implementations, information for flight itineraries and/or the itineraries themselves can be provided by the user, associated with a user profile, received from a booking/travel agency, or extracted (with permission from the user) from mail or calendar programs.

Alternative flight itineraries 116 can identify, for any given itinerary, one or more replacement flights that be substituted, e.g., as suggestions to the user, for one or more of an itinerary's planned flights. For example, one or more alternative flights can be determined and stored in the alternative flight itineraries 116, such as when it is determined that a scheduled flight in the itinerary is delayed or canceled. In some implementations, for a given flight, a set of candidate alternative flights can be determined and stored in the alternative flight itineraries 116. For example, an alternative flight can connect the same two airports with a single flight, or with two or more connecting flights. In some implementations, alternative flights can include one or more non-flight modes of transportation, such as rental car, taxi, bus, subway, train, boat or ferry.

In some implementations, the travel re-accommodation system 102 includes plural engines, some or all of which may be combined or separate, and may be co-located or distributed (e.g., connected over the network 108). A flight information engine for example, can obtain current flight status information for a collection of flights. An itinerary evaluation engine can use current flight status information to determine that a flight itinerary associated with a particular user is delayed or canceled. An alternative flight itinerary engine, for example, can determine one or more alternative flight itineraries that include one or more alternative flights for a flight that is delayed or canceled. A user interface engine, for example, can provide one or more of the group of alternative flight itineraries for display on a user device. Other engines are possible, such as engines that are used to interface with external systems and engines that use various types of ways and/or inputs to determine alternative itineraries.

In some implementations, other engines can exist, e.g., for use in selecting alternative travel itineraries. A location engine can obtain, for example, a particular user's current latitude and longitude and any other available current location information for the user and use the location information in determining alternative flight itineraries. A candidate alternative flight itinerary engine can determine, for example, one or more candidate alternative flight itineraries that have locations (e.g., origins and destinations) and times that correspond to the portions of the particular user's current itinerary. A ranking engine can rank, for example, candidate alternative flight itineraries to produce a set of ranked alternative flight itineraries. An alternative flight itinerary selection engine can select, for example, one or more of highest-ranked alternative flight itineraries to be used as the alternative flight itineraries.

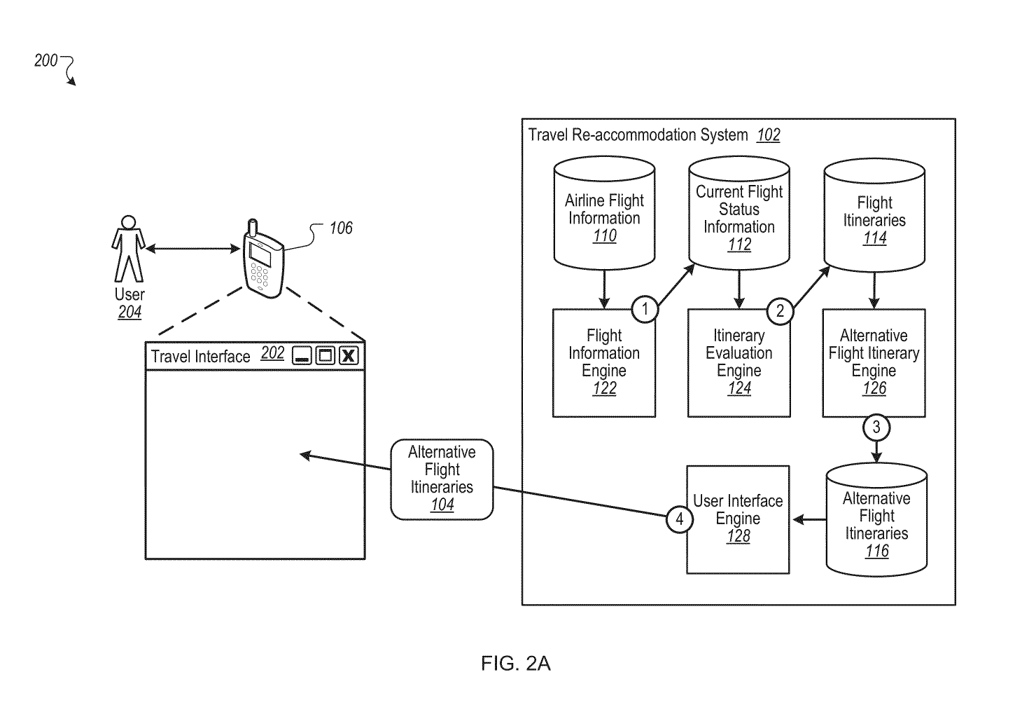

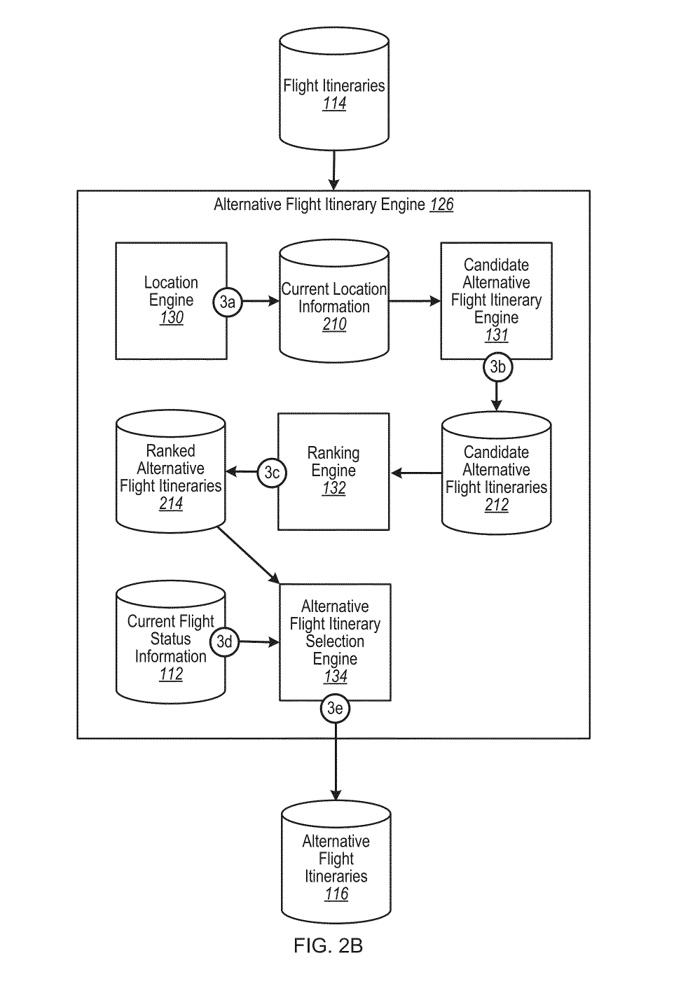

FIG. 2A is a block diagram showing example stages in a system 200 for performing re-accommodation of travel itineraries. For example, the system 200 can be used within the environment 100 described above. In some implementations, the system 200 can provide information for alternative flight itineraries for presentation in a travel interface 202 on the user device, such as for use by a user 204 with whom the alternative flight itineraries are associated.

At stage 1, the flight information engine 122 can obtain current flight status information 112 for a collection of flights, e.g., identified in the data store of airline flight information 110. For example, a flight information engine 122 can obtain or access information as to whether a particular flight is on time, delayed or canceled. The particular flight, for example, can be part of a travel itinerary associated with the user 204.

At stage 2, an itinerary evaluation engine 124 can use current flight status information to determine that a flight itinerary associated with a particular user (e.g., the user 204) is delayed or canceled. For example, for any flight that is determined by the flight information engine 122 to be delayed or canceled, the itinerary evaluation engine 124 can determine if matching flights exist in the data store of flight itineraries 114 that are associated with users. As a result, the itinerary evaluation engine 124 may identify that an in-progress itinerary for the user 204 includes Flight Y that has been canceled due to weather conditions in an associated airport. The user 204 may currently be on Flight X (e.g., that precedes Flight Y), or the user 204 may have already completed Flight X and is waiting to board Flight Y at a connecting airport.

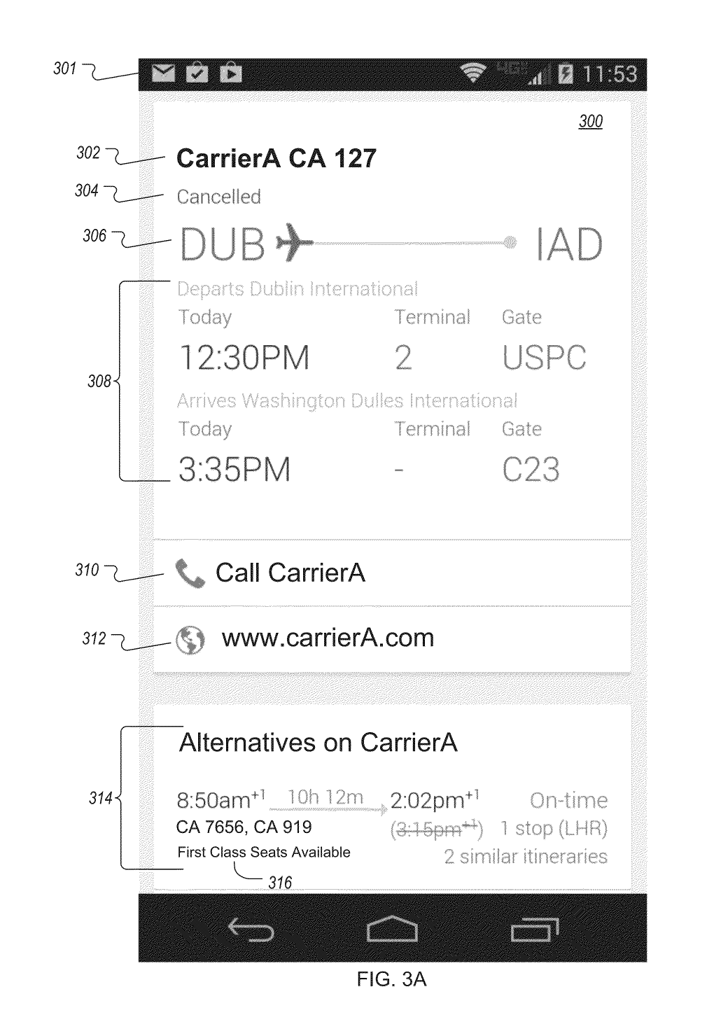

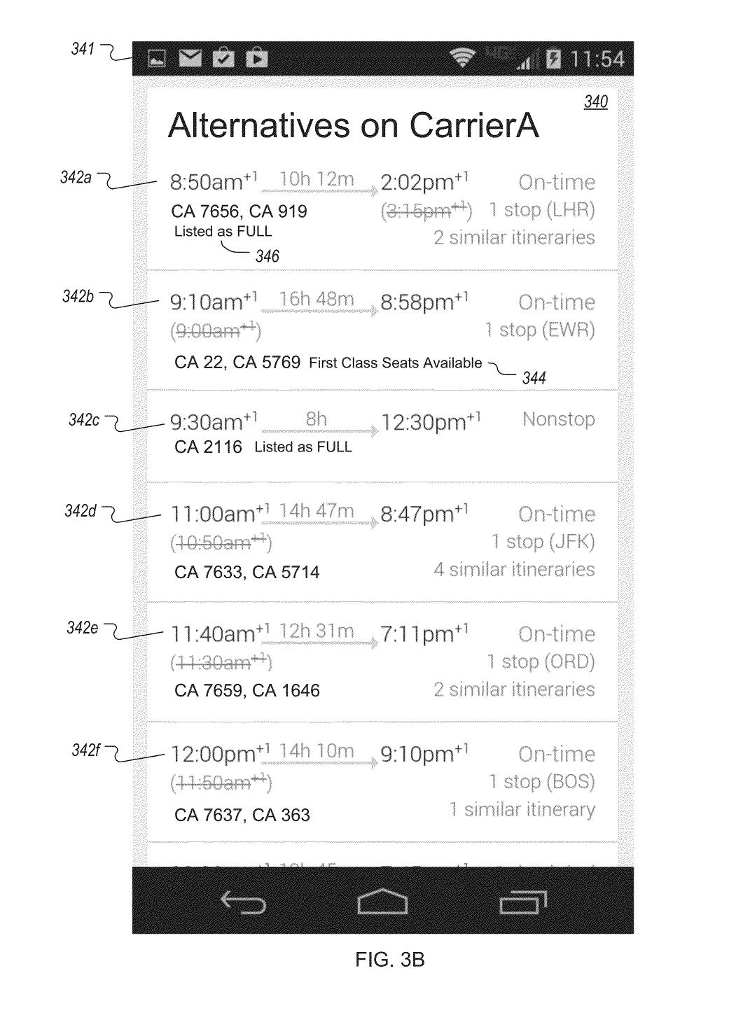

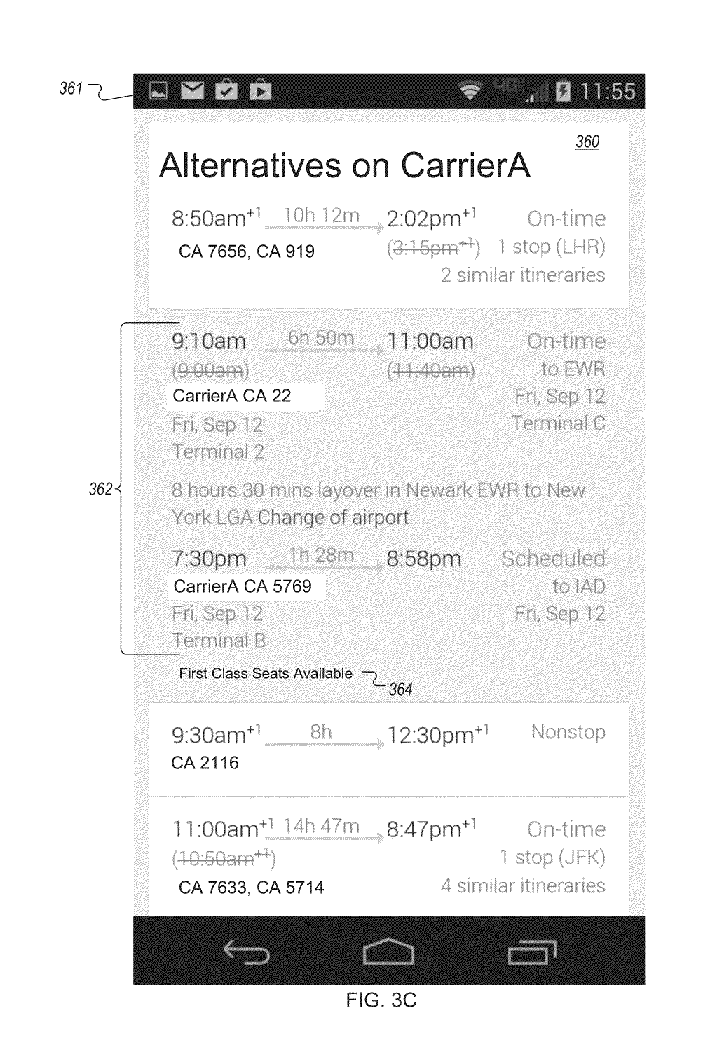

For example, FIG. 3A illustrates an example current itinerary user interface 300 displayed on a user device 301 and containing information for a flight itinerary associated with the particular user. The user interface 300 includes carrier and flight number information 302, current flight status 304 (e.g., on time, delayed, canceled), and departure and arrival locations 306. A departure and arrival detail area 308 includes departure and arrival time, terminal, and gate information. Controls 310 and 312 can be used to view a web site of the carrier or to call the carrier, respectively. An alternatives area 314 includes information about one or more alternative itineraries to the current flight. As described below, in some implementations, the alternatives area 314 is displayed in response to receiving a notification that the current flight is delayed or canceled. In some alternative implementations, if no determination has been made to provide alternatives based on the current flight status of the user's flight itinerary, the alternative area 314 can be omitted. Referring again to FIG. 2A, at stage 3, an alternative flight itinerary engine 126 can determine one or more alternative flight itineraries that include one or more alternative flights for a flight that is delayed or canceled. For example, if Flight Y has been canceled due to weather conditions, the alternative flight itinerary engine 126 can determine one or more alternative flight itineraries that include a flight that services the same starting point and destination. In some implementations, the one or more alternative flight itineraries that are determined can include multiple flights, such as a pair of flights that connect in a connecting airport not included in the original itinerary for the user 204. For example, in reference to FIG. 3A, the current flight status can be updated.

In some implementations, determining alternative flight itineraries that are alternatives to the flight itinerary that is delayed or canceled can be based on a current user location, as described below with reference to FIG. 2B.

At stage 4, the user interface engine 128 can provide one or more of the group of alternative flight itineraries for display on a user device. For example, the travel re-accommodation system 102 can provide one or more alternative flight itineraries 104 to the user device 106 of the user 204 whose flight itinerary is affected by the canceled flight. In some implementations, a received selection of a particular alternative flight itinerary can provide additional information about the itinerary. The additional information can include one or more indicators of purchasing options through one or more third-party booking providers. Alternatively, one or more indicators of purchasing options can be presented with each displayed alternative flight itinerary of the group of alternative flight itineraries. In reference to FIG. 3A, some or all of the alternative flight itineraries can be displayed in the alternatives area 314. In some implementations, alternative flight itinerary information can be pushed to a mobile device associated with the user and displayed as a notification, an e-mail, a text, or presented in some other type of user interface.

In some implementations, the user 204 can, for example, select a user interface control on a current itinerary view to view information about the alternative flight itineraries. For example, FIG. 3B illustrates an example alternative itineraries summary user interface 340 displayed on a user device 341. The alternative itineraries summary user interface 340 can be displayed automatically, for example, in response to the user device 341 receiving a notification that an itinerary of the user of the user device 341 has been delayed or canceled. As another example, the alternative itineraries summary user interface 340 can be displayed in response to the user selecting a user interface control, such as a control included in the current itinerary user interface 300 described above with respect to FIG. 3A.

The alternative itineraries summary user interface 340 includes alternative itineraries 342a-342f. The alternative itineraries 342a-342f may be determined, for example, by an alternative flight itineraries determination engine (e.g., as described above with respect to FIG. 2A and below with respect to FIG. 2B). The alternative itineraries 342a-342f can be itineraries that are alternatives to a user itinerary that has been delayed or canceled.

Although the alternative itineraries 342a-342f are each for a same carrier (e.g., “Carrier A”), the alternative itineraries summary user interface 340 can present itineraries from multiple carriers. For example, alternative itineraries for carriers that are partners with the carrier of the current itinerary can be presented.

The alternative itineraries 342a-342f can be sorted, for example, by departure time. Each of the alternative itineraries 342a-342f includes, for example, a scheduled departure time, a scheduled arrival time, a current flight status, an actual departure time (if applicable), an updated (e.g., estimated) arrival time (if applicable), flight code(s), and number of stops.

Other information can be included in an alternative itinerary 342a-342f. For example, in some implementations, an alternative itinerary 342a-342f can include an indication of seat availability. For example, an indicator 344 indicates that first-class seats may be available for the alternative itinerary 342b. As another example, an indicator 346 indicates that the alternative itinerary 342 may be full.

In some implementations, an alternative itinerary 342a-342f can be selected to view additional details about the selected alternative itinerary 342a-342f. For example, FIG. 3C illustrates an example alternative itineraries detailed view user interface 360 displayed on a user device 361. The alternative itineraries detailed view user interface 360 can be displayed, for example, in response to selection of an alternative itinerary 342a-342f as described above with respect to FIG. 3B. For example, the alternative itineraries detailed view user interface 360 includes a detailed alternative itinerary area 362 which can be displayed, for example, in response to user selection of the alternative itinerary 342b of FIG. 3B. For example, the alternative itinerary 342b can expand into the detailed alternative itinerary area 362 in response to user selection of the alternative itinerary 342b. The detailed alternative itinerary area 362 includes, for example, information about travel legs (e.g., leg duration, departing and arriving terminals and gates when available) and stops (e.g., intervening airports, stop duration).

In some implementations, processing performed by the system 200 can occur at different times. For example, processing can occur on a regular basis (e.g., every N minutes), or processing can occur when information is received that one or more flights is canceled or delayed. Other events can trigger processing, including, for example, a request by a user (e.g., the user 204) using the user device 106 who may be interested in alternative itineraries based on knowledge the user has about weather conditions in a scheduled destination.

FIG. 2B is a block diagram showing example stages for determining one or more alternative flight itineraries to the flight itinerary that is delayed or canceled. For example, FIG. 2B shows example sub-steps 3a-3e for stage 3 described above with reference to FIG. 2A for the alternative flight itinerary engine 126.

At stage 3a, a location engine 130 can obtain the user's current geographic location, e.g., latitude and longitude and/or any other current location information 210 for the user. The location engine 130 can obtain the user's current geographic location from the corresponding user device, e.g., user device 106. For example, GPS data can be obtained from the user device. In particular, the current location of the user can be associated with the locations of one or more airports, e.g., within a specified distance from the user's geographic location.

At stage 3b, the candidate alternative flight itinerary engine 131 can determine one or more candidate alternative flight itineraries 212 that have locations (e.g., origins and destinations) and times that correspond to the portions of the user's current itinerary and that take into account the current location of the user. In some implementations, the user location is associated with a particular leg of a multi-leg itinerary. For example, the user can be flying from Boston to San Francisco with a connection in Chicago. If the current user location is determined to be near Chicago O'Hare Airport, the origin in the original flight itinerary can be ignored when generating alternative flight itineraries. Instead, the alternative flight itineraries are identified from Chicago to San Francisco. Thus, the candidate alternative flight itineraries that are determined can include flights occurring within a specified time frame and based on the current geographical location of the user regardless of the origin or connection locations identified in the user's flight itinerary.

Additionally, the current user location can be used to determine whether one or more alternative airports should be considered as origin locations for alternative flight itineraries. Determining whether to include alternative airports can be based on the location of the user relative to the airports as well as the flight information indicating departure times such that the user can reach the particular airport associated with the alternative flight itinerary.

At stage 3c, the ranking engine 132 can rank the candidate alternative flight itineraries 212 to produce, e.g., ranked alternative flight itineraries 214. The ranking can be done according to one or more criteria, such as, travel and/or layover times associated with an itinerary, likelihoods that alternative flights will be on time, cost factors, adherence to the user's travel preferences, and how likely the user is to be able to be on time for a departure. In some implementations, ranking can include sorting alternative flights, including grouping and sorting alternative flights by same airline, partner airline, and/or other airline categories.

At stage 3d, the alternative flight itinerary selection engine 134 determines current flight status information for a specified number of highest-ranked candidate alternative flight itineraries. The determining can be based on information from the data store of current flight status information 112, such as real-time status information that identifies which flights are currently (or forecast to be) on time, delayed, canceled or some other status.

At stage 3e, the alternative flight itinerary selection engine 134 can select one or more of the highest-ranked ones of the ranked alternative flight itineraries 214 as the alternative flight itineraries 216, e.g., to produce the alternative flight itineraries 116. The highest-ranked candidate alternative flights that are selected can be filtered based on the current flight status of the ranked alternative flight itineraries 214.

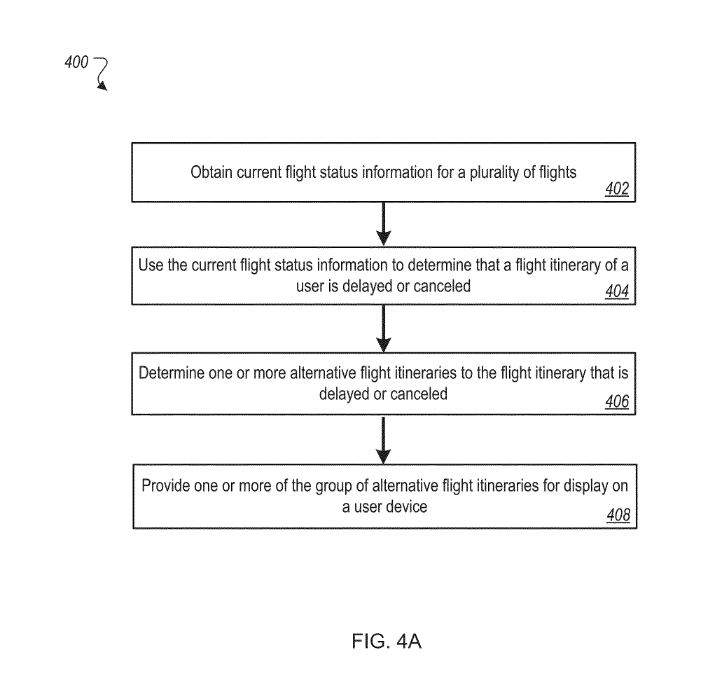

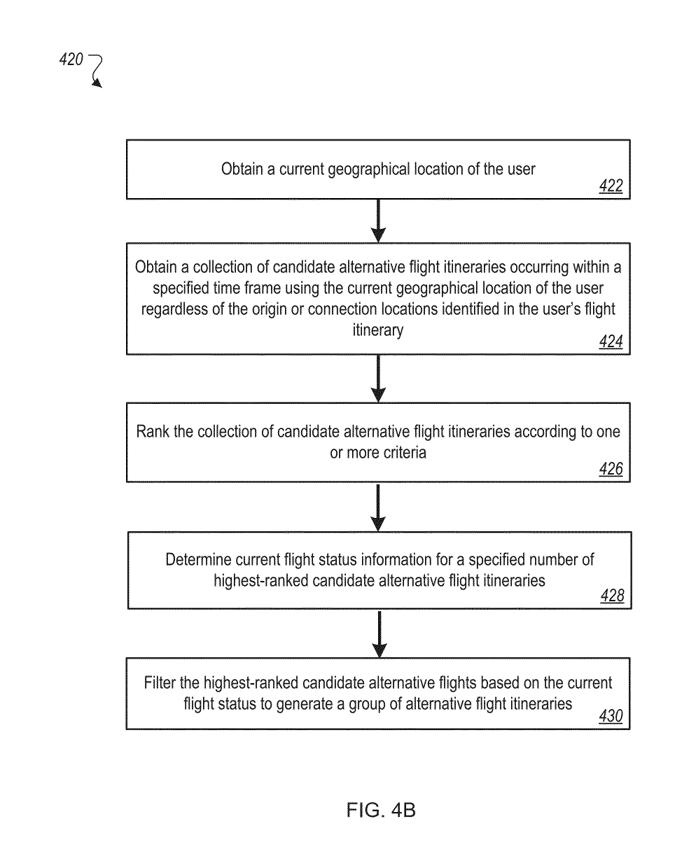

FIG. 4A is a flow diagram of an example method 400 for performing re-accommodation of travel itineraries. For convenience, the method 400 will be described with respect to a system, including one or more computing devices, that performs the method 400. For example, the method 400 can be performed by a travel re-accommodation system, such as in the travel re-accommodation system 102.

The system obtains current flight status information for a collection of flights (step 402). As an example, the flight information engine 122 can obtain or access information as to whether a particular flight is on time, delayed or canceled, e.g., using information from the data store of airline flight information 110.

The system uses the current flight status information to determine that a flight itinerary of a user is delayed or canceled (step 404). The itinerary evaluation engine 124, for example, can use current flight status information to determine that a flight itinerary associated with a particular user is delayed or canceled. For example, the determination can be made by matching flights identified as being delayed or canceled with flights in the data store of flight itineraries 114.

The system determines one or more alternative flight itineraries that are alternatives to the flight itinerary that is delayed or canceled (step 406). For example, the alternative flight itinerary engine 126 can determine one or more alternative flight itineraries that include one or more alternative flights for a flight that is delayed or canceled, as described above. Determining alternative flight itineraries are that are alternatives to the flight itinerary that is delayed or canceled is based in part on current location, as described below with reference to FIG. 4B.

The system provides one or more of the group of alternative flight itineraries for display on a user device (step 408). The user interface engine 128, for example, can provide one or more of the group of alternative flight itineraries for display on the user device 106 of the user whose flight itinerary is affected by the canceled flight.

In some implementations, providing one or more of the group of alternative flight itineraries for display includes providing an indicator for display with particular alternative flight itineraries indicating a change in airport. For example, the user interface engine 128 can include, with the one or more alternative flight itineraries 104 provided to the user device 106, information that indicates airport changes for the particular itinerary. When the information is presented in the travel interface 202, for example, changes in airports can be highlighted or otherwise indicated in the display.

In some implementations, providing one or more alternative flight itineraries for display includes ordering the one or more alternative flight itineraries according to the estimated actual times instead of scheduled times for each alternative flight itinerary. For example, information included with the one or more alternative flight itineraries 104 can be used in presenting the alternative flight itineraries in order by scheduled start time of the respective itinerary. In some implementations, other ways of presenting the itineraries can be used, including, for example, using information associated with actual flight status information, presenting scores that can indicate how well each respective itinerary meets the user's schedule, the user's preferences, the user's budget, an respective airport's ease and/or history of making a connecting flight, and/or other factors that can be scored.

FIG. 4B is a flow diagram of an example method 420 for determining one or more alternative flight itineraries to the flight itinerary that is delayed or canceled. For convenience, the method 420 will be described with respect to a system, including one or more computing devices, that performs the method 420. For example, the method 420 can be performed by the system 200, such as in the environment 100.

The system obtains a current geographical location of the user (step 422). For example, the location engine 130 can obtain current location information 210 for the user, such as the user's current geographic location, e.g., latitude and longitude. In some implementations, current location information can also include the name of the city or airport in which the user is currently located, or a location at which the user will shortly arrive if currently on a flight with an associated destination at that location. In some implementations, the location engine 130 can obtain the user's current geographic location from the corresponding user device, e.g., user device 106. For example, GPS data can be obtained from the user device. In particular, the current location of the user can be associated with the locations of one or more airports, e.g., within a specified distance from the user's geographic location.

A collection of candidate alternative flight itineraries occurring within a specified time frame is obtained using the current geographical location of the user (step 424). Since the user may have already begun their itinerary, the user's actual location is used in determining alternative flight itineraries rather than the origin location identified in the user's flight itinerary. The candidate alternative flight itinerary engine 131, for example, can determine one or more candidate alternative flight itineraries 212 that have locations (e.g., origins and destinations) and times that correspond to the portions of the user's current itinerary. In some implementations, the user's current itinerary may be the user's original itinerary with or without modifications based on other cancelations or delays in previous flights. The time frame used for obtaining candidate alternative flight itineraries can begin, for example, at the current time and extend a specified amount of time which can be fixed or variable, for example, at least to the time of a currently-scheduled flight (that may be canceled or delayed), or at least to a departure time of the last of potential candidate alternative flights at or near a particular location.

In some implementations, obtaining the collection of candidate alternative flight itineraries includes determining one or more candidate alternative flight itineraries 212 having an origin airport within a threshold distance to the current geographical location of the user. For example, the candidate alternative flight itinerary engine 131 can limit consideration of candidate flights to those flights that depart from airports within a threshold distance (e.g., 50 miles) from the user's current location, e.g., included in the current location information 210. In some implementations, consideration of candidate flights, particularly at alternative airports, can also be based on a time threshold, e.g., based on a time that the user is predicted to be able to travel to a potential new airport or other departing location. In some implementations, estimates of distance and/or time can be based on current or predicted conditions, such as current weather conditions, predicted weather conditions, airport closures, and/or other factors.

In some implementations, the threshold distance depends on a departure time of the candidate alternative flight itinerary. For example, in determining one or more candidate alternative flight itineraries 212, the candidate alternative flight itinerary engine 131 can consider departure times of candidate flights. In some implementations, other information associated with the candidate alternative flight itineraries 212 can be used, such as estimated times for a user to get through airport security, estimated times to navigate through an airport, estimated times to travel from one airport to another airport (such as by ground transportation), and/or other factors.

The candidate alternative flight itinerary engine 131 can consider one or more obstacles involved in selecting alternative flights. For example, the determination process can consider aspects such as determining an alternative flight that is provided by the same carrier as the user's currently scheduled flight, or whether an alternative flight is offered by a different carrier that has a good relationship, e.g., including re-accommodation agreements, with the carrier of the original flight.

In some implementations, the current geographic location of the user corresponds to a connection location of the user's flight itinerary, and the candidate alternative flight itineraries have the connection location as an origin location and the destination of the user's flight itinerary as a destination location. For example, one or more of the candidate alternative flight itineraries 212 determined by the candidate alternative flight itinerary engine 131 can include, as a starting point, a flight originating from a connecting airport (e.g., Chicago) in the user's original itinerary. The destination of the alternative flight itineraries can be a different destination, e.g., an airport within a threshold distance of the original destination airport, or can be the same destination.

The system ranks the collection of candidate alternative flight itineraries according to one or more criteria (step 426). As an example, the ranking engine 132 can rank the candidate alternative flight itineraries 212 using the one or more criteria to generate ranked alternative flight itineraries 214. The criteria can include, for example, various times associated travel and/or layover times associated with an itinerary, likelihoods that alternative flights will be on time, cost factors, adherence to the user's travel preferences, cost factors, or how likely the user is to be able to be on time for a departure.

The system determines current flight status information is determined for a specified number of highest-ranked candidate alternative flight itineraries (step 428). For example, the alternative flight itinerary selection engine 134 can receive information from the data store of current flight status information 112. The information that is received, for example, can include real-time status information for any flights identified in the ranked alternative flight itineraries 214. For example, the real-time status information can identify which flights are currently (or forecast to be) on time, delayed, canceled or some other status. The ranking can be modified based on the current flight status information.

The system filters the highest-ranked candidate alternative flights based on the current flight status to generate a group of alternative flight itineraries (step 430). For example, alternative flight itinerary selection engine 134 can select one or more of the highest-ranked ones of the ranked alternative flight itineraries 214 as the alternative flight itineraries 216. One or more alternative flight itineraries can then be provided to the user for display, for example, as described above with respect to step 408 of FIG. 4A.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded using, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a current geographical location of the user,
obtaining a collection of candidate alternative flight itineraries occurring within a specified time frame using the current geographical location of the user regardless of the origin or connection locations identified in the user's flight itinerary,
ranking the collection of candidate alternative flight itineraries according to one or more criteria,
determining current flight status information for a specified number of highest-ranked candidate alternative flight itineraries, and
filtering the highest-ranked candidate alternative flights based on the current flight status to generate a group of alternative flight itineraries; and
providing one or more of the group of alternative flight itineraries for display on a user device.

2. The method of claim 1, wherein the current geographic location of the user corresponds to a connection location of the user's flight itinerary and wherein the candidate alternative flight itineraries have the connection location as an origin location and the destination of the user's flight itinerary as a destination location.

3. The method of claim 1, wherein obtaining the collection of candidate alternative flight itineraries includes determining one or more candidate alternative flight itineraries having an origin airport within a threshold distance to the current geographical location of the user.

4. The method of claim 3, wherein the threshold distance depends on a departure time of the candidate alternative flight itinerary.

5. The method of claim 1, wherein providing one or more of the group of alternative flight itineraries for display includes providing an indicator for display with particular alternative flight itineraries indicating a change in airport.

6. The method of claim 1, wherein providing one or more alternative flight itineraries for display includes ordering the one or more alternative flight itineraries according to the estimated actual times instead of scheduled times for each alternative flight itinerary.

7. A system comprising:
one or more computers configured to perform operations comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a current geographical location of the user,
obtaining a collection of candidate alternative flight itineraries occurring within a specified time frame using the current geographical location of the user regardless of the origin or connection locations identified in the user's flight itinerary,
ranking the collection of candidate alternative flight itineraries according to one or more criteria,
determining current flight status information for a specified number of highest-ranked candidate alternative flight itineraries, and
filtering the highest-ranked candidate alternative flights based on the current flight status to generate a group of alternative flight itineraries; and
providing one or more of the group of alternative flight itineraries for display on a user device.

8. The system of claim 7, wherein the current geographic location of the user corresponds to a connection location of the user's flight itinerary and wherein the candidate alternative flight itineraries have the connection location as an origin location and the destination of the user's flight itinerary as a destination location.

9. The system of claim 7, wherein obtaining the collection of candidate alternative flight itineraries includes determining one or more candidate alternative flight itineraries having an origin airport within a threshold distance to the current geographical location of the user.

10. The system of claim 9, wherein the threshold distance depends on a departure time of the candidate alternative flight itinerary.

11. The system of claim 7, wherein providing one or more of the group of alternative flight itineraries for display includes providing an indicator for display with particular alternative flight itineraries indicating a change in airport.

12. The system of claim 7, wherein providing one or more alternative flight itineraries for display includes ordering the one or more alternative flight itineraries according to the estimated actual times instead of scheduled times for each alternative flight itinerary.

13. A computer storage medium encoded with a computer program, the program comprising instructions that when executed by one or more computers cause the one or more computers to perform operations comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a current geographical location of the user,
obtaining a collection of candidate alternative flight itineraries occurring within a specified time frame using the current geographical location of the user regardless of the origin or connection locations identified in the user's flight itinerary,
ranking the collection of candidate alternative flight itineraries according to one or more criteria,
determining current flight status information for a specified number of highest-ranked candidate alternative flight itineraries, and
filtering the highest-ranked candidate alternative flights based on the current flight status to generate a group of alternative flight itineraries; and
providing one or more of the group of alternative flight itineraries for display on a user device.

14. The computer storage medium of claim 13, wherein the current geographic location of the user corresponds to a connection location of the user's flight itinerary and wherein the candidate alternative flight itineraries have the connection location as an origin location and the destination of the user's flight itinerary as a destination location.

15. The computer storage medium of claim 13, wherein obtaining the collection of candidate alternative flight itineraries includes determining one or more candidate alternative flight itineraries having an origin airport within a threshold distance to the current geographical location of the user.

16. The computer storage medium of claim 15, wherein the threshold distance depends on a departure time of the candidate alternative flight itinerary.

17. The computer storage medium of claim 13, wherein providing one or more of the group of alternative flight itineraries for display includes providing an indicator for display with particular alternative flight itineraries indicating a change in airport.

18. The computer storage medium of claim 13, wherein providing one or more alternative flight itineraries for display includes ordering the one or more alternative flight itineraries according to the estimated actual times instead of scheduled times for each alternative flight itinerary.
